(19) United States
(12) Patent Application Publication
(10) Pub. No.: US 2024/0278408 A1
(43) Pub. Date: Aug. 22, 2024

(54) Piston Bore for a Hydraulic Power Tool

(71) Applicant: Milwaukee Electric Tool Corporation, Brookfield, WI (US)

(72) Inventors: Mathew R. Rentmeester, Wauwatosa, WI (US); Rishiraj Gaddam, Brookfield, WI (US); Tony Breitbach, Brookfield, WI (US)

(21) Appl. No.: 18/444,243

(22) Filed: Feb. 16, 2024

Related U.S. Application Data
(60) Provisional application No. 63/486,195, filed on Feb. 21, 2023.

(51) Int. Cl. B25F 5/00; C25D 3/12; C25D 5/48; C25D 7/04

(52) U.S. Cl. CPC B25F 5/005; C25D 3/12; C25D 5/48; C25D 7/04

(57) ABSTRACT

A hydraulic tool, such as a hydraulic crimper/cutter is provided. The tool includes a hydraulic pump defining a hydraulic piston bore and a hydraulic piston arranged within the hydraulic piston bore. The hydraulic piston bore includes a nickel matrix silicon carbide (e.g., Nikasil®) coating to increase wear resistance and lubricity of the piston bore, without increasing the size or weight of the tool.

### CROSS-REFERENCE TO RELATED APPLICATIONS

This application claims the benefit of U.S. Provisional Application No. 63/486,195, filed Feb. 21, 2023, which is herein incorporated by reference in its entirety.

### BACKGROUND

Hydraulic crimpers and cutters are hydraulic power tools for performing work (e.g., crimping or cutting) on a workpiece. In such tools, a hydraulic pump pressurizes hydraulic fluid via movement of a hydraulic piston. The piston slides against a piston sleeve arranged within a piston chamber (e.g., a piston bore). However, the piston sleeve adds weight, size, and cost to the tool, which is undesirable to an end user. Thus, there is a desire to provide more affordable, smaller, and lighter weight hydraulic crimpers and cutters.

### SUMMARY

Some aspects of the disclosure provide a linerless hydraulic piston bore for use with hydraulic power tools, such as a hydraulic crimper/cutter tool. The tool includes a hydraulic pump defining a piston bore, a hydraulic piston arranged within the piston bore, and a coating applied to an interior surface of the piston bore. In one example, the coating is arranged between the interior surface of the piston bore and the piston.

Some aspects of the disclosure provide a method of applying a coating to a hydraulic piston bore. The method includes machining a piston bore to a first diameter, applying a coating to an interior surface of the piston bore, and honing an exterior surface of the coating to a second, different diameter. In one example, the coating is selected from the group consisting of aluminum, copper, magnesium, manganese, nickel, phosphorous, silicon, silicon carbide, zinc, and combinations thereof.

Some aspects of the disclosure provide a linerless hydraulic piston bore for use with hydraulic power tools, such as a hydraulic crimper/cutter tool. The tool includes a crimper/cutter assembly including a head portion and a body portion. The tool further includes a hydraulic pump arranged within the body portion of the crimper/cutter assembly. In one example, the hydraulic pump includes a hydraulic piston arranged within a hydraulic piston bore. In another example, the hydraulic piston bore includes a coating arranged on an interior surface of the piston bore. The tool further includes a ram arranged within the body portion and hydraulically connected to the hydraulic pump and a movable jaw arranged within the head portion. In one example, the jaw actuates in response to corresponding actuation of the ram via pressurization of hydraulic fluid within the hydraulic pump. In one particular example, the coating is a nickel matrix silicon carbide coating.

### BRIEF DESCRIPTION OF THE DRAWINGS

The accompanying drawings, which are incorporated in and form a part of this specification, illustrate embodiments of the disclosure and, together with the description, serve to explain the principles of embodiments of the disclosure:

FIG. 1 is a side view of a hydraulic power tool according to aspects of the present disclosure.

FIG. 2 is a perspective view of crimper/cutter assembly of the hydraulic power tool of FIG. 1.

FIG. 3 is a cross-sectional view of the crimper/cutter assembly shown in FIG. 2.

FIG. 4 is an enlarged cross-sectional view of a piston bore of the crimper/cutter assembly as shown in area IV of FIG. 3.

FIG. 5 is another cross-sectional view of the piston bore shown in FIG. 4.

FIG. 6 is a diagrammatic view of surface layers of the piston bore shown in FIG. 5.

FIG. 7 is a flowchart of a method of applying a coating to the piston bore of FIG. 5.

### DETAILED DESCRIPTION

The following discussion is presented to enable a person skilled in the art to make and use embodiments of the disclosure. Given the benefit of this disclosure, various modifications to the illustrated embodiments will be readily apparent to those skilled in the art, and the principles herein can be applied to other embodiments and applications without departing from embodiments of the disclosure. Thus, embodiments of the disclosure are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The disclosed piston bore (e.g., linerless piston bore) will be described with respect to an example hydraulic tool. However, it should be understood that any one or more example embodiments of the disclosed piston bore could be incorporated in alternate forms of a hydraulic tool. Furthermore, it should be understood that one or more example embodiments of the disclosed piston bore could be used outside of the context of a hydraulic pump system and could more generally be used in a mechanism and/or mechanisms that generate/generates reciprocation.

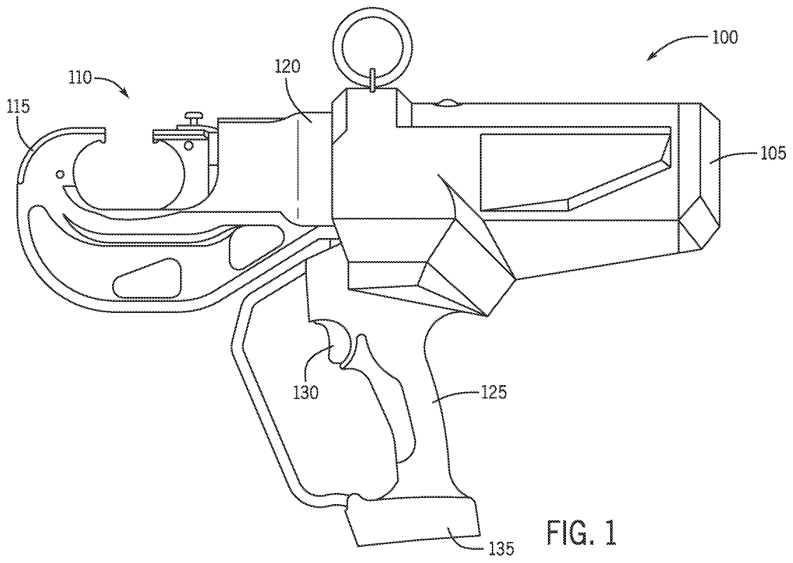

With reference to FIG. 1, a hydraulic tool 100 according to an example of the present disclosure is shown. In one example, the hydraulic tool 100 may be a crimping tool. However, in other examples, the hydraulic tool 100 may be a cutting tool. In yet other examples, the tool 100 may be interchangeable between a crimping tool and a cutting tool via interchangeability of a die (e.g., a crimping die or a cutting die) positioned within a head of the tool.

The hydraulic tool 100 may include a housing 105 that receives a crimper/cutter assembly 110 having a head 115 and a body 120. In one example, the body 120 of the assembly 110 may be positioned within the housing 105 of the tool while the head 115 of the assembly 110 is positioned outside of the housing 105. The housing 105 may further include a handle 125 to permit a user to grip and maneuver the tool 100. In one example, the user may activate or deactivate operation of the tool 100 via actuation of a trigger 130 positioned on the handle 125 For example, a user may activate the tool 100 by depressing the trigger 130 and may deactivate the tool 100 by releasing the trigger 130. In one particular example, the tool 100 may include a battery receptacle 135 configured to receive and secure a battery (e.g., a rechargeable lithium ion battery, etc.) to power the tool 100. However, in other examples, the tool 100 may include a power cord to supply power to the tool 100. In one example, the head 115 generally defines a C-shape. However, in other examples, the head 115 may define other geometries, such as a U-shape.

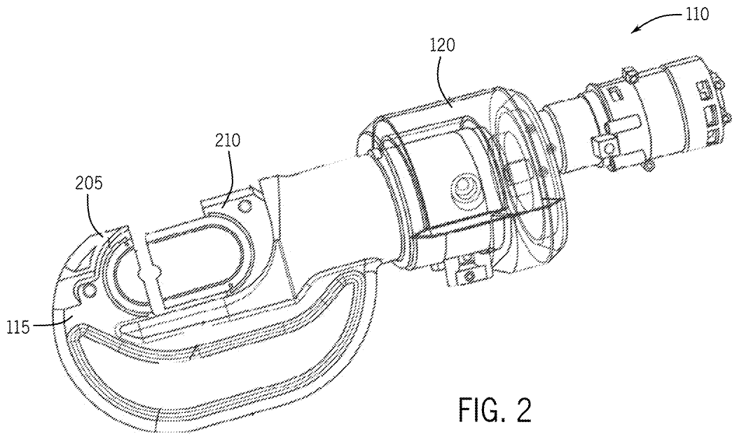

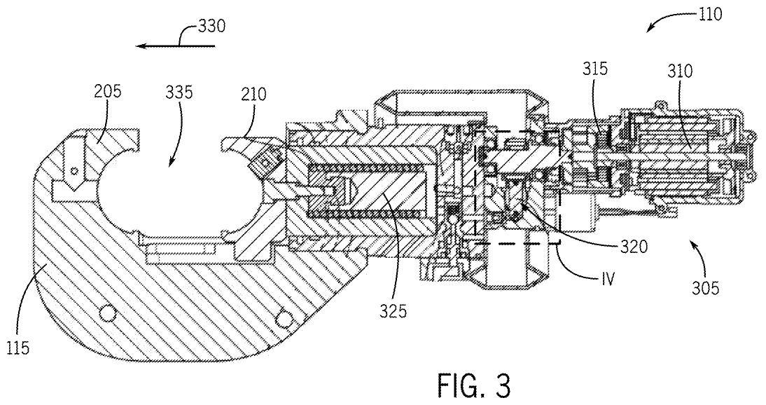

FIGS. 2 and 3 illustrate an example of the crimper/cutter assembly 110. In the illustrated example, the assembly 110 can include a powertrain 305, which may be powered by the battery connected to the battery receptacle 135. In one example, the powertrain 305 may include a motor 310 (e.g., an electric motor), a gear train 315, and a hydraulic pump 320. In one example, actuation of the trigger 130 may activate the motor 310, which pressurized hydraulic fluid via the hydraulic pump 320. The pressurized hydraulic fluid may then actuate a ram 325 as shown by arrow 330. For example, the ram 325 can move forward (e.g., to shrink an opening 335 defined by the head 115) in order to commence a crimp or cut of a workpiece, such as an electrical connector or pipe. The ram can also move backward (e.g., to expand the opening 335 defined by the head 115) to release a workpiece.

The head 115 of the hydraulic tool 100 can include a pair of jaws (e.g., a fixed jaw 205 and a moveable jaw 210). In one example, the moveable jaw 210 may be actuated by corresponding actuation of the ram 325, while the fixed jaw 205 remains stationary regardless of the position of the ram 325.

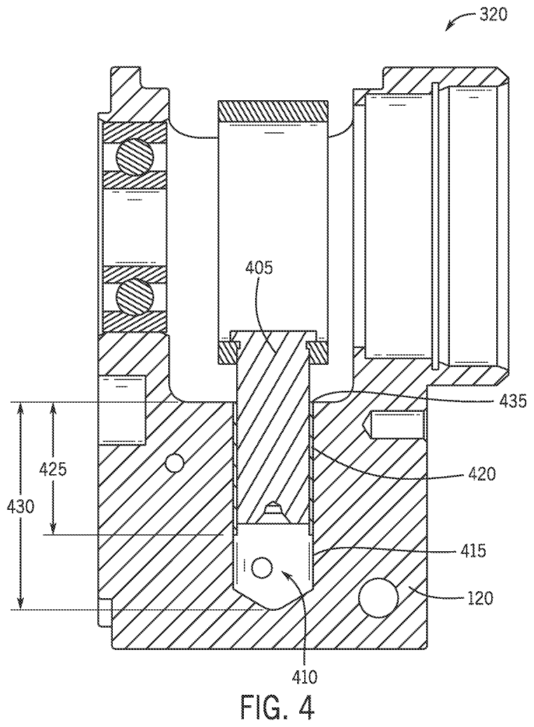

FIG. 4 shows an example of a portion of the hydraulic pump 320 of the tool 100. In one example, the pump 320 may include a piston 405 arranged within a piston bore 410 of the pump. The piston 405 is configured to reciprocate within the piston bore 410 to pressurize fluid (e.g., hydraulic fluid) within the pump 320. Thus, fluid pressurized by the pump may be used to actuate the ram 325.

In one example, the piston bore 410 may be in the form of a blind hole (e.g., not extending through the entire body 120). Further, the piston bore 410 may include an inner surface 415 that includes a coating 420 on a portion of the surface 415. In one example, the coating 420 may be a plated (e.g., electroplated) material. The coating 420 may be used in lieu of a separate piston sleeve to reduce the weight, size, and complexity of the tool 100.

The coating 420 can cover at least a portion of the surface 415. For example, the coating 420 may define a height 425 that is less than a height 430 of the inner surface 415 of the piston bore 410. In some examples, the coating 420 may cover at least 20%, at least 50%, at least 60%, at least 70%, at least 80%, or at least 90% of the height 430 of the surface 415. In one particular example, the height 425 of the coating 420 may extend along 60-70% of the height 430 of the surface 415 starting from a first end 435 (e.g., an open end) of the piston bore 410.

In one example, the coating 420 can mitigate wear and increase lubricity of the piston bore 410. Thus, the overall service life of the tool 100 may be increased while the overall dimensions (e.g., size, weight) of the tool 100 may be decreased. To mitigate wear and increase lubricity multiple surface treatment materials are envisioned for the coating 420. For example, the coating 420 can include, elemental materials, metals, alloys, ceramic materials, microparticles, nanoparticles, or combinations thereof. For example, the coating 420 can include components selected from the group consisting of aluminum, copper, magnesium, manganese, nickel, phosphorous, silicon, silicon carbide, zinc, or combinations thereof. In one example, the coating 420 can include aluminum and silicon. In another example, the coating 420 can include nickel and silicon.

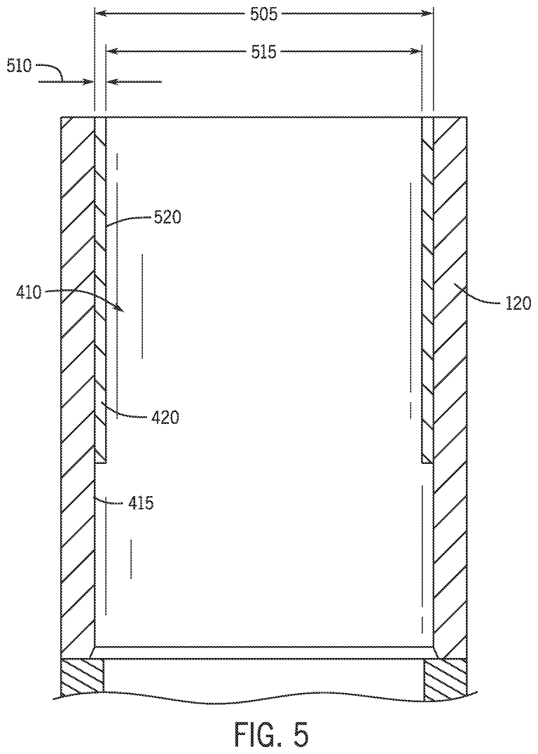

In one particular example, the coating 420 can include nickel and silicon carbide such as Nikasil®. More specifically, the coating 420 can include a nickel matrix with particles of silicon carbide embedded within the nickel matrix. The silicon carbide particles can have a largest cross-sectional dimension of between 0.5 and 5 microns. The coating can include between 10 vol % and 50 vol % of silicon carbide in nickel. In one example, an exterior surface 520 (see, e.g., FIG. 5) of the coating 420 can exhibit between 20% and 30% silicon carbide as measured by surface area.

As mentioned previously, coating 420 may have a hardness value that is greater than a hardness value of the body 120. For example, the body may be made from an aluminum material, while the coating 420 may be made from a nickel and silicon carbide mixture having a hardness value of between 40 and 100 HRC. In another example, the coating 420 can have a hardness value of between about 50 and 90 HRC. In yet another aspect, the coating 420 may have a hardness value of about 55 HRC. In one example, as mentioned previously, the coating 420 may have a lower coefficient of friction than the surface 415 of the piston bore 410.

In some examples, a hybrid coating that includes a multi-compound material may be used for coating 420. In yet another example, the piston bore 410 may go through a hard anodizing process. In a particular example, the piston bore 410 can be hard anodized to include a dense anodic coating of aluminum oxide as coating 420. As should be appreciated, the coating 420 increases wear resistance and lubricity of the piston bore 410, thus extending the service life of the tool 100.

Turning to FIG. 5, various dimensions of the piston bore 410 are shown. As should be appreciated, a diameter 505 of the piston bore 410 corresponding to the surface 415 (e.g., the surface without the coating 420) may be dimensionally larger than a diameter 515 corresponding to an exterior surface 520 of the coating 420 of the piston bore 410. Put differently, the diameter 505 of the surface 415 corresponds to a pre-treatment diameter of the piston bore 410. In one example, the diameter 505 can be between about 5 mm and about 10 mm. In one particular example, the diameter 505 can be between about 6 mm and about 7 mm. The diameter 515 corresponds to a post-treatment diameter of the piston bore 410. In one example, the diameter 515 can be about 90-97% of the diameter 505. In one particular example, the diameter 515 may be about 95-97% of the diameter 505. As should be appreciated, the coating 420 may define a thickness 510 defined as the difference between the diameter 505 and the diameter 515. In one example, the thickness 510 of the coating 420 may be a first thickness when the coating 420 is applied to the surface 415 of the piston bore 410. In one example, the thickness 510 of the coating 420 may be between about 0.100 mm and about 0.200 mm. In one particular example, the first thickness may be about 0.175 mm. Following application of the coating 420, the coating may be honed down to a predetermined final diameter of the piston bore 410. In one example, the thickness 510 of the coating 420 may be between about 0.100 mm and about 0.200 mm. In one particular example, the final thickness of the coating 420 may be about 0.124 mm.

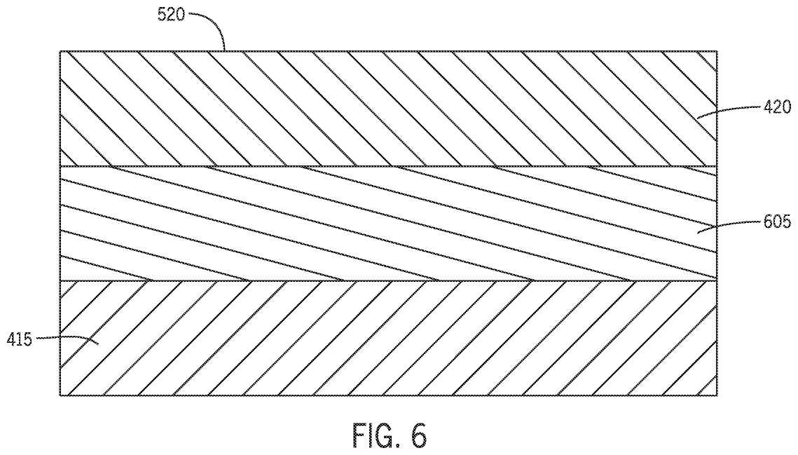

Looking to FIG. 6, in some examples, an interlayer 605 may be arranged between the surface 415 and the coating 420. The interlayer 605 can be applied to the surface 415 to remove any existing oxides and smooth imperfections. The interlayer 650 can have a thickness of between about 3 microns and about 10 microns. In some examples, the interlayer 605 can be a pure metallic layer, such as nickel. The interlayer 605 may improve adhesion of the coating 420 to the surface 415 of the piston bore 410. In other examples, the coating 420 may be applied directly to the surface 415 of the piston bore 410, without the interlayer 605.

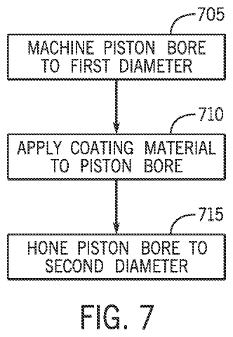

FIG. 7 shows a flowchart of a method of applying the coating 420 to the piston bore 410. In one example, the piston bore 410 may be prepared (e.g., cleaned) prior to the application of the coating 420. For example, preparation of the surface 415 of the piston bore 410 may include mechanically cleaning the surface 415 of debris or grease or chemically removing oxide layers from the surface 415.

In one example, at stage 705, the piston bore 410 may be machined or cast with a larger (e.g., oversize) bore diameter 505 than is needed for the piston 405. As described previously, the piston bore 410 may be machined or cast as a blind hole with only a single opening. For example, the pre-treatment diameter 505 of the piston bore 410 can be machined or cast to a predetermined oversize, where the diameter 505 is substantially larger than needed to accommodate the piston 405 to compensate for the thickness 510 of the coating 420. In another example, the bore 410 may be machined or cast at a diameter corresponding to the piston 405 in non-additive surface treatment options.

At state 710, the coating 420 may be applied to the surface 415, In one example, the coating 420 may be applied to the surface 415 of the bore 410 via electroplating. For example, nickel can be electroplated onto the surface 415. In one particular example, the bore 410 can be electroplated with nickel and silicon carbide particles so that the silicon carbide particles are incorporated into the coating 420. In another example, the bore 410 can be electroplated first with a nickel interlayer followed by a layer having a combination of nickel and silicon carbide. It is contemplated that the coating 420 can be applied to any piston-facing surface, including, but not limited to the surface 415 of the piston bore 410.

In another example, the coating 420 can be deposited on the bore surface 415 using electroless plating methods where no electrical current is applied to deposit the coating 420. Electroless plating can include exposing the surface 415 to a chemical mixture with at least one metal or a metal salt and at least one reducing agent, and optionally complexing agents, buffers, and stabilizers. When exposed to the surface 415 a reaction between the chemical mixture and the surface 415 results in the application of the coating 420 on the surface 415. The electroless plating method can deposit the coating at a rate of at least 5 microns per hour, at least 10 microns per hour, at least 25 microns per hour, or at least 50 microns per hour. In other examples, the surface 415 may be coated by spraying the coating 420 onto the surface 415 (e.g., thermospraying).

At stage 715, after the coating 420 is applied, the exterior surface 520 of the coating 420 may define a first diameter of the piston bore 410 that is larger than desired. Thus, the piston bore 410 may be honed or machined to the predetermined final diameter (e.g., diameter 515). Further, the coating 420 may be treated to improve smoothness of the coating (i.e., lower the coefficient of friction). For example, the bore 410 including the coating 420 may be finish honed, plateau honed, or crosshatch honed. In one example, the honing the piston bore 410 may improve the microscopic features of the exterior surface 520 to enable free articulation of the piston 405 within the piston bore 410.

In some implementations, devices or systems disclosed herein can be utilized, manufactured, or installed using methods embodying aspects of the disclosure. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosure, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein in the context of cable connectors, unless otherwise limited or defined, “axial” and derivatives refer to an axial direction of an elongate cable that is received into (e.g., fully through) the relevant connector. Thus, for example, with a cylindrical cable received through a housing and insert of a cable connector, an axial direction is a direction along a centerline of the cable within the housing and insert. Correspondingly, unless otherwise limited or defined, “radial” indicates a direction perpendicular to axial, and the terms “inward” and “outward” indicate movement transverse to axial, toward and away from a reference centerline, respectively.

Additionally, unless otherwise specified or limited, the terms “about” and “approximately,” as used herein with respect to a reference value, refer to variations from the reference value of ±25% or less, inclusive of the endpoints of the range. Similarly, the term “substantially equal” (and the like) as used herein with respect to a reference value refers to variations from the reference value of less than ±15%, inclusive. Where specified, “substantially” can indicate in particular a variation in one numerical direction relative to a reference value. For example, “substantially less” than a reference value (and the like) indicates a value that is reduced from the reference value by 15% or more, and “substantially more” than a reference value (and the like) indicates a value that is increased from the reference value by 15% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the disclosure. Given the benefit of this disclosure, various modifications to these embodiments will be readily apparent to those skilled in the art, and the principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. A hydraulic tool, comprising:
a hydraulic pump defining a piston bore;
a hydraulic piston arranged within the piston bore; and
a coating applied to an interior surface of the piston bore, the coating in direct contact with the interior surface of the piston bore and arranged between the interior surface of the piston bore and the piston.

2. The hydraulic tool of claim 1, wherein piston bore does not include a piston sleeve arranged between the interior surface of the piston bore and piston.

3. The hydraulic tool of claim 1, wherein the coating is a nickel matrix silicon carbide coating.

4. The hydraulic tool of claim 3, wherein an exterior surface of the coating includes between about 20% and about 30% silicon carbide.

5. The hydraulic tool of claim 1, wherein the coating is applied to the interior surface of the piston bore via electroplating.

6. The hydraulic tool of claim 1, wherein the coating is applied to the interior surface of the piston bore at a first thickness and is honed down to a second, different thickness.

7. The hydraulic tool of claim 6, wherein the first thickness is about 0.175 mm, and wherein the second thickness is about 0.124 mm.

8. The hydraulic tool of claim 1, wherein the piston bore is a blind hole.

9. The hydraulic tool of claim 8, wherein the interior surface of the piston bore defines a height, and wherein the coating includes a height that is less than the height of the interior surface of the piston bore.

10. The hydraulic tool of claim 9, wherein the height of the coating is about 60-70 percent of the height of the interior surface of the piston bore.

11. The hydraulic tool of claim 1, wherein the coating has a hardness value of between about 40 and about 60 HRC.

12. The hydraulic tool of claim 1, further comprising:
a crimper/cutter assembly, the assembly including a head portion and a body portion;
wherein the body portion includes the hydraulic pump and a ram hydraulically connected to the hydraulic pump; and
wherein pressurization of hydraulic fluid within the hydraulic pump actuates the ram to elicit corresponding actuation of a jaw positioned within the head portion of the crimper/cutter assembly.

13. A method of applying a coating to a piston bore, comprising:
machining a piston bore to a first diameter;
applying a coating directly to an interior surface of the piston bore; and
honing an exterior surface of the coating to a second, different diameter;
wherein the coating is selected from the group consisting of aluminum, copper, magnesium, manganese, nickel, phosphorous, silicon, silicon carbide, zinc, and combinations thereof.

14. The method of claim 13, wherein the coating is a nickel matrix silicon carbide coating.

15. The method of claim 14, wherein the coating is applied to the interior surface of the piston bore via electroplating.

16. The method of claim 13, wherein the coating is applied to the interior surface of the piston bore at a first thickness and is honed down to a second, different thickness.

17. The method of claim 16, wherein the first thickness is about 0.175 mm, and wherein the second thickness is about 0.124 mm.

18. The method of claim 13, wherein the piston bore is a blind hole.

19. The method of claim 18, wherein the interior surface of the piston bore defines a height, and wherein the coating includes a height that is less than the height of the interior surface of the piston bore.

20. A hydraulic tool, comprising:
a crimper/cutter assembly, the assembly including a head portion and a body portion;
a hydraulic pump arranged within the body portion of the crimper/cutter assembly, the hydraulic pump including a hydraulic piston arranged within a hydraulic piston bore, and the hydraulic piston bore including a coating applied directly to an interior surface of the piston bore;
a ram arranged within the body portion and hydraulically connected to the hydraulic pump; and
a movable jaw arranged within the head portion, the jaw to actuate in response to corresponding actuation of the ram via pressurization of hydraulic fluid within the hydraulic pump;
wherein the coating is a nickel matrix silicon carbide coating.
